(19) United States
(12) Patent Application Publication
(10) Pub. No.: US 2025/0266730 A1
(43) Pub. Date: Aug. 21, 2025

(54) STATOR AND METHOD FOR PRODUCING STATOR

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventor: Kanzo ISHIHARA, Osaka-Shi, Osaka (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/859,267

(22) PCT Filed: Apr. 5, 2023
(86) PCT No.: PCT/JP2023/014124

§ 371 Date: Oct. 23, 2024

(30) Foreign Application Priority Data
Apr. 26, 2022 (JP) 2022-072387

(51) Int. Cl. H02K 3/48; H02K 1/16; H02K 3/34; H02K 15/064; H02K 15/122

(52) U.S. Cl. CPC H02K 3/48; H02K 1/16; H02K 3/34; H02K 15/064; H02K 15/122; H02K 2215/00

(57) ABSTRACT

A stator includes an annular stator core, a coil, an insulating resin, and a positioning component (first positioning component). The stator core includes a plurality of slots that are arranged in an annular shape and extend through the stator core in an axial direction. The coil includes an insertion portion that passes through the slots. The insulating resin includes a continuous filling portion that is located in a center portion in the axial direction inside a slot of the plurality of slots and that continuously fills a space between an inner wall of the slot and the insertion portion. The positioning component (first positioning component) positions the insertion portion in a state where, on one side in the axial direction with respect to the continuous filling portion, at least a portion of the positioning component enters between the inner wall of the slot and the insertion portion.

### CROSS-REFERENCE TO RELATED APPLICATIONS

This application is the U.S. national stage of PCT/JP2023/014124 filed on Apr. 5, 2023, which claims priority of Japanese Patent Application No. JP 2022-072387 filed on Apr. 26, 2022, the contents of which are incorporated herein.

### TECHNICAL FIELD

The present disclosure relates to a stator and a method for producing a stator.

### BACKGROUND

JP 2013-62911A and JP 2020-33433A disclose a stator. In this stator, a coil is fixed to a stator core via an insulating paper.

In the above-described stator, it is desired that heat dissipation of a coil is improved.

In view of this, an object of the present disclosure is to provide a technique which can improve heat dissipation of a coil.

### SUMMARY

A stator according to the present disclosure is a stator including: an annular stator core; a coil; an insulating resin; and a positioning component, in which the stator core includes a plurality of slots that are arranged in an annular shape and extend through the stator core in an axial direction, the coil includes an insertion portion that passes through a slot of the plurality of slots, the insulating resin includes a continuous filling portion located in a center portion in the axial direction inside the slot, and that continuously fills a space between an inner wall of the slot and the insertion portion, and the positioning component positions the insertion portion in a state where, on one side in the axial direction with respect to the continuous filling portion, at least a portion of the positioning component enters between the inner wall of the slot and the insertion portion.

A method for producing a stator according to the present disclosure is a method for producing a stator including: an annular stator core and a coil segment, the stator core having a plurality of slots that are arranged in an annular shape and extend through the stator core in an axial direction, the method including: a placement step of placing a jig so as to cover at least a portion of an opening edge on one side in the axial direction of a slot of the plurality of slots; an insertion step of inserting the coil segment in the slot from the one side in the axial direction after placing the jig, and a filling step of continuously filling a space between an inner wall of the slot and the coil segment in a center portion in the axial direction inside the slot, with an insulating resin.

### Advantageous Effects

According to the present disclosure, heat dissipation of a coil can be improved.

### BRIEF DESCRIPTION OF DRAWINGS

FIG. 1 is a perspective view of a state in which a stator according to a first embodiment has been cut along the axial direction.

FIG. 2 is a perspective view of a stator core.

FIG. 3 is a cross-sectional view showing a portion of a cross-section of the stator taken along a direction orthogonal to the axial direction, as viewed from another side in the axial direction.

FIG. 4 is a perspective view of a first positioning component as viewed from one side in the axial direction.

FIG. 5 is a perspective view of the first positioning component as viewed from the other side in the axial direction.

FIG. 6 is a cross-sectional view showing how a coil segment is inserted into a slot.

FIG. 7 is a cross-sectional view showing a state in which the coil segment is positioned by the first positioning component and a second positioning component.

FIG. 8 is a cross-sectional view showing a state where the coil segment has been bent along an inclined surface.

FIG. 9 is an illustrative view for illustrating a first alternative embodiment of the second positioning component.

FIG. 10 is an illustrative view for illustrating a second alternative embodiment of the second positioning component.

### DETAILED DESCRIPTION OF PREFERRED EMBODIMENTS

Hereinafter, embodiments of the present disclosure will be listed and described.

In a first aspect, a stator according to the present disclosure is a stator including: an annular stator core; a coil; an insulating resin; and a positioning component, wherein the stator core includes a plurality of slots that are arranged in an annular shape and extend through the stator core in an axial direction, the coil includes an insertion portion that passes through a slot of the plurality of slots, the insulating resin includes a continuous filling portion located in a center portion in the axial direction inside the slot, and that continuously fills a space between an inner wall of the slot and the insertion portion, and the positioning component positions the insertion portion in a state where, on one side in the axial direction with respect to the continuous filling portion, at least a portion of the positioning component enters between the inner wall of the slot and the insertion portion.

With this configuration, since the insulating paper is not interposed between the inner wall of the slot and the insertion portion in the continuous filling portion, the heat of the coil is easily dissipated. Further, since the insertion portion is positioned in the state where at least a portion of the positioning component enters between the inner wall of the slot and the insertion portion, the position of the insertion portion in the slot is easily stabilized, and as a result, heat dissipation performance of the insertion portion via the insulating resin is easily stabilized.

In a second aspect, the stator according to the first aspect, In which the positioning component is disposed so as to extend in the axial direction inside and outside of the slot, and positions the insertion portion on both the inside and outside of the slot.

With this configuration, since the insertion portion is positioned on the inside and outside of the slot, the position of the insertion portion is more easily stabilized.

In a third aspect, the stator according to the first or the second aspects, further including a second positioning component that positions the insertion portion in a state where, on the other side in the axial direction with respect to the continuous filling portion, at least a portion of the second positioning component enters between the inner wall of the slot and the insertion portion, and the insertion portions are positioned by the positioning component and the second positioning component.

With this configuration, since the insertion portion is positioned on both sides in the axial direction, the position of the insertion portion is more easily stabilized.

In a fourth aspect, the stator according to the third aspect, wherein the coil has an extended portion that extends from one end of the insertion portion via a bent portion, and the positioning component has an inclined surface that extends along the extended portion.

With this configuration, since the displacement of the extended portion is restricted by the inclined surface, the orientation of the coil is more easily stabilized.

In a fifth aspect, a method for producing a stator including an annular stator core and a coil segment, the stator core having a plurality of slots that are arranged in an annular shape and extend through the stator core in an axial direction, the method including: a placement step of placing a jig so as to cover at least a portion of an opening edge on one side in the axial direction of a slot of the plurality of slots; an insertion step of inserting the coil segment in the slot from the one side in the axial direction after placing the jig, and a filling step of continuously filling a space between an inner wall of the slot and the coil segment in a center portion in the axial direction inside the slot, with an insulating resin.

With this configuration, the coil segment is easily inserted into the slot so as not to come into contact with the stator core. Further, since the insulating resin continuously fills the space between the inner wall of the slot and the coil segment, the heat of the coil segment is easily dissipated via the insulating resin, and as a result, heat dissipation of the coil can be improved.

In a sixth aspect, the method for producing a stator according to the fifth aspect, wherein in the filling step, the slot is filled with the insulating resin while an opening on the one side in the axial direction of the slot is closed by the jig.

With this configuration, leakage of the insulating resin through the opening on the one side in the axial direction of the slot to the outside is easily prevented by the jig.

In a seventh aspect, the method for producing a stator according to the fifth or the sixth aspects, wherein the jig includes a base portion disposed at an end portion on the one side in the axial direction of the stator core and a protrusion that protrudes in a tubular shape from the base portion and through which the coil segment is passed, an outer peripheral surface of the protrusion includes an outer peripheral tapered surface that is tapered toward a protruding end of the protrusion, and in the placement step, the jig is disposed by inserting the protrusion into the slot from the protruding end side.

With this configuration, since the outer peripheral tapered surface is formed on the protruding end side of the protrusion, even if the coil segment deviates slightly when the coil segment is inserted into the protrusion, the outer peripheral tapered surface guides the coil segment into the protrusion. Accordingly, with this configuration, the protrusion of the jig is easily inserted into the slot.

In an eighth aspect, the method for producing a stator according to any one of the fifth through the seventh aspects, further including: an attachment step of attaching a second jig to the coil segment that has been inserted into the slot in the insertion step, from the other side in the axial direction, wherein, in the filling step, the slot is filled with the insulating resin while an opening on the one side in the axial direction of the slot is closed by the jig and an opening on the other side in the axial direction is closed by the second jig, the second jig includes a second base portion disposed at an end portion on the other side in the axial direction of the stator core, and a second protrusion that protrudes in a tubular shape from the second base portion, an inner peripheral surface of the second protrusion includes an inner peripheral tapered surface formed such that a hole in the second protrusion widens toward the protruding end, and in the attachment step, the second jig is attached to the coil segment by inserting the coil segment into the second jig from the protruding end side of the second protrusion.

With this configuration, leakage of the insulating resin to the outside of the slot on both sides in the axial direction is easily prevented by the jig. Further, since the inner peripheral tapered surface is included in the inner peripheral surface of the second protrusion, even if the coil segment deviates slightly when the coil segment is inserted into the second protrusion, the inner peripheral tapered surface guides the coil segment to the inside of the second protrusion. Accordingly, with this configuration, the second jig is easily attached to the coil segment.

In a ninth aspect, the method for producing a stator according to the eighth aspect, wherein an outer peripheral surface of the second protrusion has a second outer peripheral tapered surface that is tapered toward the protruding end, the method further including a second placement step of placing the second jig at the end portion on the other side in the axial direction of the stator core by inserting the second protrusion into the slot from the protruding end side.

With this configuration, since the second outer peripheral tapered surface is formed on the protruding end side of the second protrusion, even if the second protrusion deviates slightly when the second protrusion is inserted into the slot from the protruding end side, the second outer peripheral tapered surface guides the second protrusion into the slot. Accordingly, this configuration makes it easy for the second jig to be inserted into the slot. That is, since the inner peripheral tapered surface and the second outer peripheral tapered surface are formed on the protruding end side of the second protrusion, the second jig is easily attached to the coil segment and inserted into the slot.

In a tenth aspect, the method for producing a stator according to any one of the fifth through the ninth aspects, wherein the base portion of the jig includes an inclined surface that guides the coil segment into the protrusion, and in the placement step, the jig is placed such that the inclined surface is placed on the one side in the axial direction with respect to the protrusion.

With this configuration, even if the coil segment deviates slightly when the coil segment is inserted into the protrusion from the one side in the axial direction, the inclined surface guides the coil segment into the protrusion. Accordingly, this configuration makes it easy for the coil segment to be inserted into the protrusion from the one side in the axial direction.

In an eleventh aspect, the method for producing a stator according to the tenth aspect, further including a bending step of bending the coil segment along the inclined surface.

With this configuration, the inclined surface that guides the coil segment can be used to bend the coil segment.

### First Embodiment

### Configuration of Stator 1

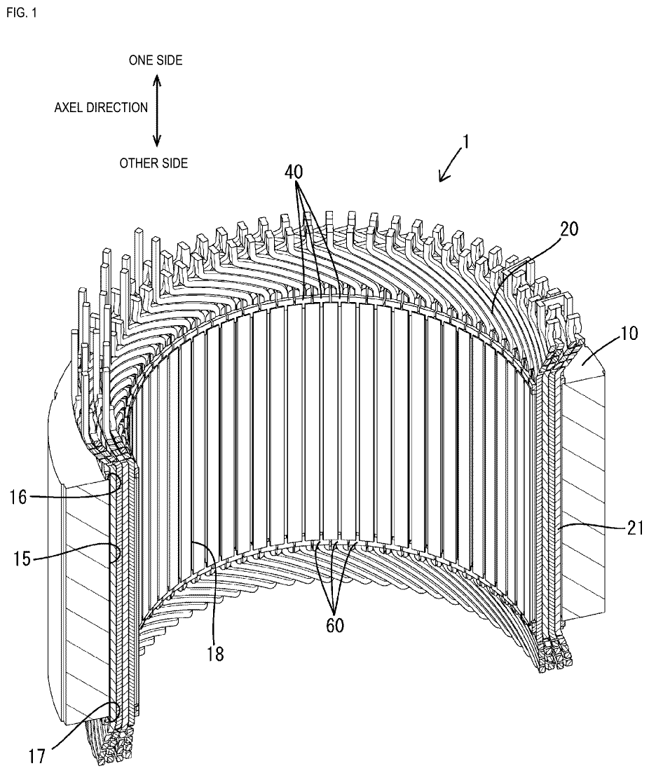

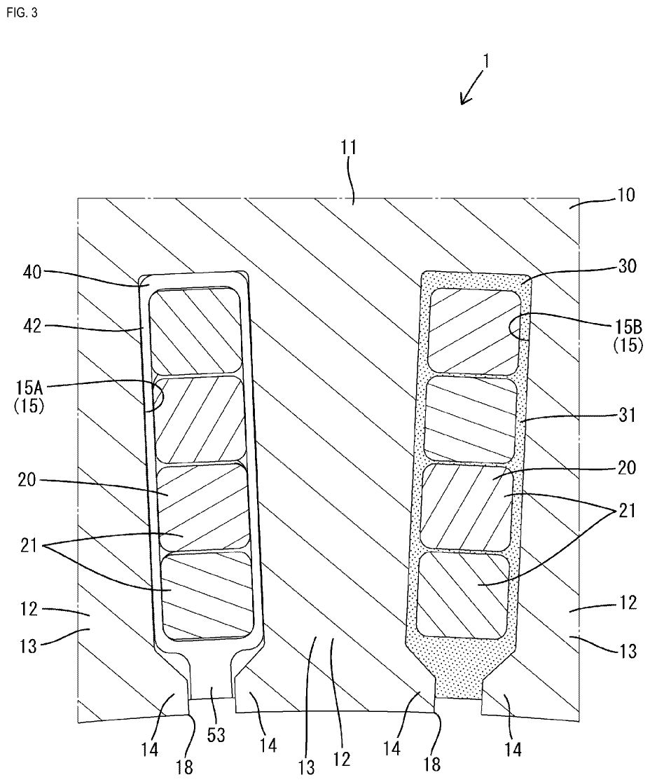

A stator 1 of the first embodiment is used as a component of a rotating electrical device (specifically, a motor). As shown in FIG. 1, the stator 1 has an annular shape, and more specifically, a circular ring shape. The stator 1 includes a stator core 10, a coil 20, an insulating resin 30 (see FIG. 3), a first positioning component 40, and a second positioning component 60. Note that the insulating resin 30 is not shown in FIG. 1.

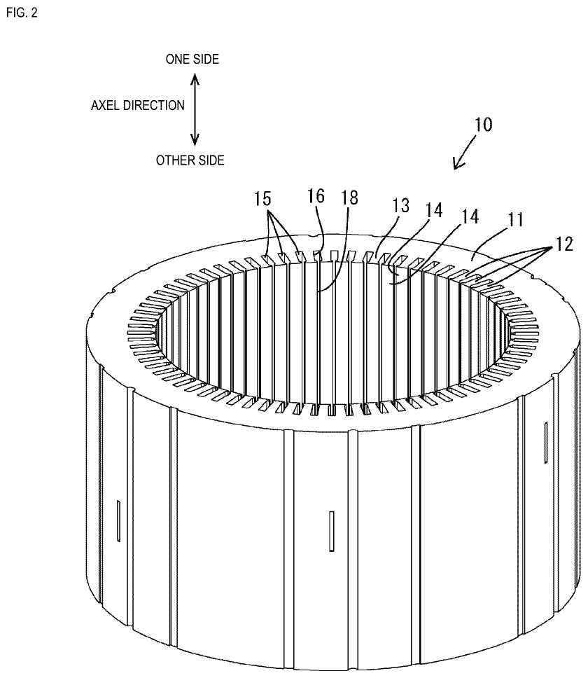

As shown in FIG. 2, the stator core 10 has an annular shape, more specifically, a ring shape. Hereinafter, the radial direction of the stator core 10 is referred to as a “radial direction”, the axial direction of the stator core 10 is referred to as an “axial direction”, and the circumferential direction of the stator core 10 is referred to as a “circumferential direction”.

As shown in FIGS. 2 and 3, the stator core 10 includes a yoke portion 11 and teeth portions 12. The yoke portion 11 has an annular shape, more specifically, a ring shape. The plurality of teeth portions 12 are arranged in an annular shape along the inner peripheral surface of the yoke portion 11. The teeth portions 12 are disposed at intervals in the circumferential direction. The teeth portions 12 protrude radially inward from the inner peripheral surface of the yoke portion 11. The teeth portions 12 each have a wall shape extending along the radial direction and the axial direction. The teeth portions 12 each have a teeth body 13 having a wall shape extending along the radial direction and the axial direction, and teeth projections 14 that project from the distal end portion of the teeth body 13 (i.e., radially inner end portion) to both sides in the circumferential direction.

The stator core 10 may be a laminated steel plate manufactured by laminating a plurality of magnetic steel plates (e.g., silicon steel plates) in the thickness direction, or a powder magnetic core formed by press-molding insulation-coated magnetic particles.

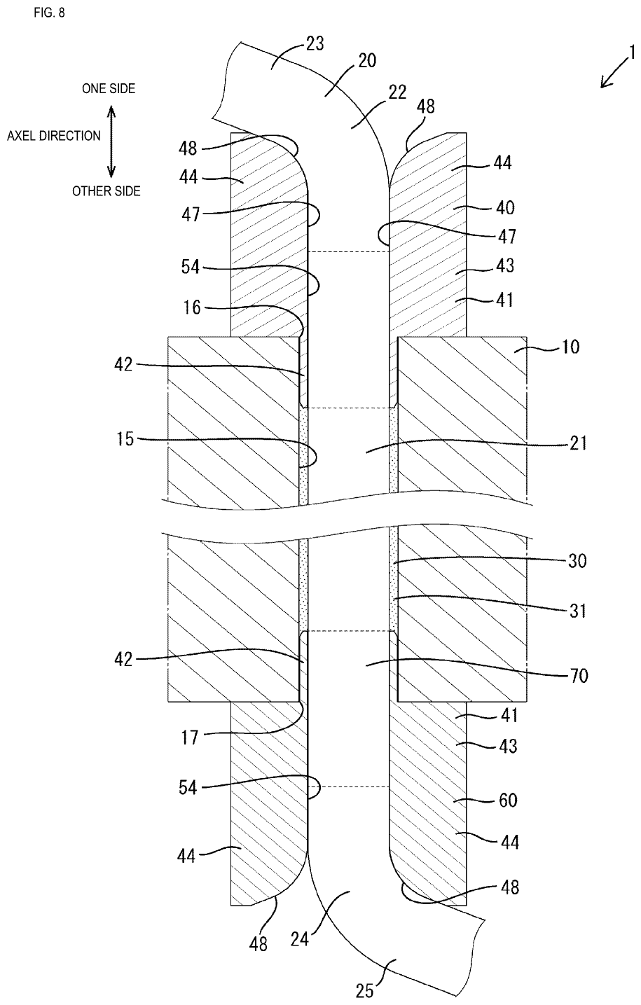

The stator core 10 includes a plurality of slots 15 as shown in FIG. 2. The slots 15 are arranged side by side in an annular shape. The slots 15 extend through the stator core 10 in the axial direction. As shown in FIGS. 2 and 8, the slots 15 each have a first opening 16, a second opening 17, and a third opening 18. The first opening 16 is formed in a surface on the one side in the axial direction of the stator core 10. The second opening 17 is formed in a surface on the other side in the axial direction of the stator core 10. The third opening 18 is formed in a surface on the radially inner side of the stator core 10. The third opening 18 is continuous with the first opening 16 and the second opening 17. As shown in FIG. 3, the slots 15 are each formed by two adjacent teeth portions 12. The two sides in the circumferential direction of each slot 15 are defined by the teeth portions 12, and the outer surface in the radial direction of each slot 15 is defined by the yoke portion 11.

The coil 20 may be a distributed winding or a concentrated winding. As shown in FIG. 1, the coil 20 is wrapped around the teeth portions 12 through the slots 15. The coil 20 has a rectangular cross section taken along the direction orthogonal to the length direction. The coil 20 includes a core wire that forms a conductive path and a coating portion that coats the core wire. The core wire is a conductor. The core wire is a rectangular wire, and has a rectangular cross section taken along a direction orthogonal to the length direction. The coating portion forms an insulation layer. The material for the coating portion is not particularly limited. In the present embodiment, the coating portion is a low dielectric constant enamel with a low dielectric constant. The coating portion may be mainly composed of a thermosetting resin such as polyvinyl formal, thermosetting polyurethane, thermosetting acrylic, epoxy, thermosetting polyester, thermosetting polyesterimide, aromatic polyamide, thermosetting polyamideimide, or thermosetting polyimide. Further, the coating portion may be mainly composed of a thermoplastic resin such as polyetherimide, polyphenylene ether, polyether sulfone, polyphenylene sulfide, polyether ether ketone, or thermoplastic polyimide. Here, the “main component” is the component with the highest content, for example, the component contained in an amount of 50% by mass or more.

As shown in FIG. 8, the coil 20 includes an insertion portion 21 passing through the slot 15. The coil 20 includes a first extended portion 23 that extends from one end of the insertion portion 21 via a first bent portion 22, and a second extended portion 25 that extends from the other end of the insertion portion 21 via a second bent portion 24. The first bent portion 22 corresponds to an example of a “bent portion”. The first extended portion 23 corresponds to an example of an “extended portion”.

The insulating resin 30 fills the inside of the slots 15. In FIG. 3, a slot 15A and a slot 15B are illustrated as the slots 15. The insulating resin 30 is not shown in the slot 15A. The slot 15B filled with the insulating resin 30 is shown. The insulating resin 30 includes a continuous filling portion 31 that continuously fills a space between the inner wall of the slot 15B (slot 15) and the insertion portions 21 at the center portion in the axial direction of the stator core 10. The continuous filling portion 31 continuously fills the slot 15B (slot 15) except for both end portions in the axial direction. According to this configuration, since the insulating paper is not interposed between the inner wall of the slot 15 and the insertion portions 21 in each continuous filling portion 31, the heat of the coil 20 is easily dissipated.

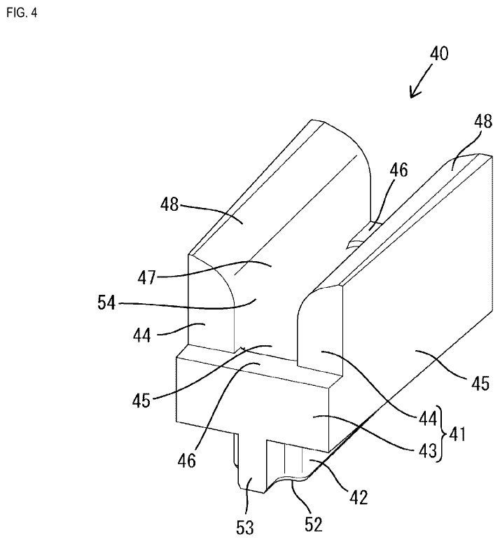

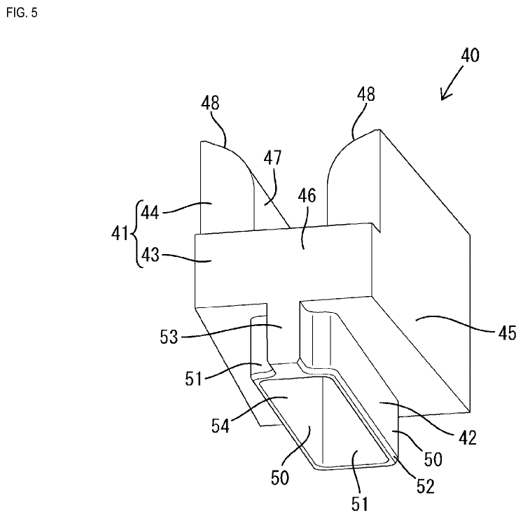

The first positioning component 40 corresponds to an example of a “positioning component” and an example of a “jig”. The first positioning component 40 has insulating properties, and is formed by a material such as resin or ceramic. As shown in FIGS. 4 and 5, the first positioning component 40 has an annular shape. The first positioning component 40 includes a base portion 41 and a protrusion 42.

The base portion 41 includes an annular base portion 43 and projections 44. The annular base portion 43 has an annular shape. The annular base portion 43 includes a pair of long portions 45 and a pair of short portions 46. The pair of long portions 45 extend linearly in parallel with each other. The pair of long portions 45 extend along the radial direction. The short portions 46 are shorter than the long portions 45. The pair of short portions 46 extend linearly in parallel with each other. The pair of short portions 46 extend along a direction orthogonal to the long portions 45. The pair of short portions 46 extend along the circumferential direction. The pair of long portions 45 and the pair of short portions 46 form an annular shape as a whole.

The projections 44 project from the base portion 41 toward one side in the axial direction. The projections 44 respectively project from the pair of long portions 45 toward one side in the axial direction. That is, the projections 44 are provided in a pair. The pair of projections 44 respectively have facing surfaces 47 that face each other and inclined surfaces 48 that face each other. The pair of facing surfaces 47 face each other in the circumferential direction. The facing surfaces 47 are surfaces extending along the axial direction and the radial direction. At least a portion of the facing surfaces 47 is flush with an inner peripheral surface of the annular base portion 43 (more specifically, surfaces of the pair of long portions 45 that face each other). The pair of inclined surfaces 48 are inclined such that the distance from each other increases toward the projecting side (the one side in the axial direction) of the projections 44. Radially inner end portions of the pair of projections 44 are disposed radially inward of the inner peripheral surface of the annular base portion 43 and radially inward of the inner peripheral surface of the protrusion 42. Radially outer end portions of the pair of projections 44 are disposed radially outward of the inner peripheral surface of the annular base portion 43, and radially outward of the inner peripheral surface of the protrusion 42. The radially inner end portions of the pair of facing surfaces 47 and the pair of inclined surfaces 48 are disposed radially inward of the inner peripheral surface of the annular base portion 43 and radially inward of the inner peripheral surface of the protrusion 42. The radially outer end portions of the pair of facing surfaces 47 and the pair of inclined surfaces 48 are disposed radially outward of the inner peripheral surface of the annular base portion 43, and radially outward of the inner peripheral surface of the protrusion 42.

The protrusion 42 protrudes in a tubular shape from the base portion 41 toward the opposite side to the projections 44 side (the other side in the axial direction). The protrusion 42 protrudes in a tubular shape from the inner periphery of the tubular base portion 41. The protrusion 42 has a quadrangular tube shape. The protrusion 42 includes a pair of long plate portions 50 and a pair of short plate portions 51. The pair of long plate portions 50 extend linearly in parallel with each other. The pair of long plate portions 50 extend along a radial direction. The short plate portions 51 are shorter than the long plate portions 50. The pair of short plate portions 51 extend linearly in parallel with each other. The pair of short plate portions 51 extend in a direction orthogonal to the long plate portions 50. The pair of short plate portions 51 extend along the circumferential direction. The pair of long portions 50 and the pair of short portions 51 form a tube shape (more specifically, a quadrangular tube shape) as a whole.

The inner peripheral surface of the protrusion 42 is continuous with the inner peripheral surface of the base portion 41 (annular base portion 43) without a stepped portion. The outer peripheral surface of the protrusion 42 includes an outer peripheral tapered surface 52 that is tapered toward the protruding end.

The first positioning component 40 includes an inner protrusion 53 protruding radially inward from the outer peripheral surface of the protrusion 42. As shown in FIG. 3, the inner protrusion 53 is disposed in a gap between the teeth projections 14 in the circumferential direction.

As shown in FIGS. 4 and 5, the first positioning component 40 has a pair of positioning surfaces 54. The pair of positioning surfaces 54 position the insertion portions 21 in the circumferential direction. The pair of positioning surfaces 54 are constituted by the pair of facing surfaces 47, the inner peripheral surface of the annular base portion 43 (more specifically, the surfaces of the pair of long portions 45 that face each other), and the inner peripheral surface of the protrusion 42 (more specifically, the surfaces of the pair of long plate portions 50 that face each other).

The second positioning component 60 corresponds to an example of a “second jig”. In the present embodiment, the second positioning component 60 has the same form as the first positioning component 40, and thus a detailed description thereof will be omitted.

As shown in FIG. 8, the first positioning component 40 positions the insertion portions 21 in a state where the protrusion 42 enters between the inner wall of the slot 15 and the insertion portions 21 on the one side in the axial direction with respect to the continuous filling portion 31. In the circumferential direction, the protrusion 42 positions the insertion portions 21 in a state where the protrusions 42 enter between the inner wall of the slot 15 and the insertion portions 21, on both sides of each insertion portion 21. In the radial direction, the protrusion 42 positions the insertion portions 21 in a state where the protrusion 42 enters between the inner wall of the slot 15 and the innermost insertion portion 21 and the outermost insertion portion 21 among the plurality of insertion portions 21 radially arranged side by side. According to this configuration, since the protrusion 42 of the first positioning component 40 positions the insertion portions 21 in a state where the protrusion 42 enters between the inner wall of the slot 15 and the insertion portions 21, the positions of the insertion portions 21 in the slot 15 are easily stabilized, and as a result, the heat dissipation performance of the insertion portion 21 via the insulating resin 30 is easily stabilized. The first positioning component 40 is disposed so as to extend in the axial direction inside and outside of each slot 15, and positions the insertion portions 21 on both the inside and outside of the slot 15. More specifically, the inner peripheral surface of the protrusion 42 of the first positioning component 40 positions the insertion portions 21 inside the slot 15, and the inner peripheral surface of the annular base portion 43 and the pair of facing surfaces 47 of the pair of projections 44 position the insertion portions 21 outside of the slot 15. According to this configuration, since the insertion portions 21 are positioned on the inside and outside of the slot 15, the positions of the insertion portions 21 are more easily stabilized.

As shown in FIG. 8, on the other side in the axial direction with respect to the continuous filling portion 31, similarly to the first positioning component 40, the second positioning component 60 positions the insertion portions 21 in a state where the protrusion 42 enters between the inner wall of the slot 15 and the insertion portions 21.

As shown in FIG. 8, the insertion portions 21 are positioned by the first positioning component 40 and the second positioning component 60. According to this configuration, since the insertion portions 21 are positioned on both sides in the axial direction, the position of the insertion portion 21 is more easily stabilized.

As shown in FIG. 8, the inclined surfaces 48 of the first positioning component 40 are disposed along the first extended portions 23 of the coil 20. The inclined surfaces 48 of the second positioning component 60 are disposed along the second extended portions 25 of the coil 20. According to this configuration, displacement of the first extended portions 23 is restricted by the inclined surfaces 48 of the first positioning component 40, and displacement of the second extended portions 25 is restricted by the inclined surfaces 48 of the second positioning component 60. Accordingly, the orientation of the coil 20 is more easily stabilized.

As shown in FIG. 3, a plurality (in the present embodiment, four) of insertion portions 21 are disposed in one slot 15. The plurality of insertion portions 21 are radially arranged in a row in one slot 15.

### Method for Producing Stator 1

The method for producing a stator 1 includes a first placement step, an insertion step, an attachment step, a second placement step, a filling step, a bending step, and a welding step.

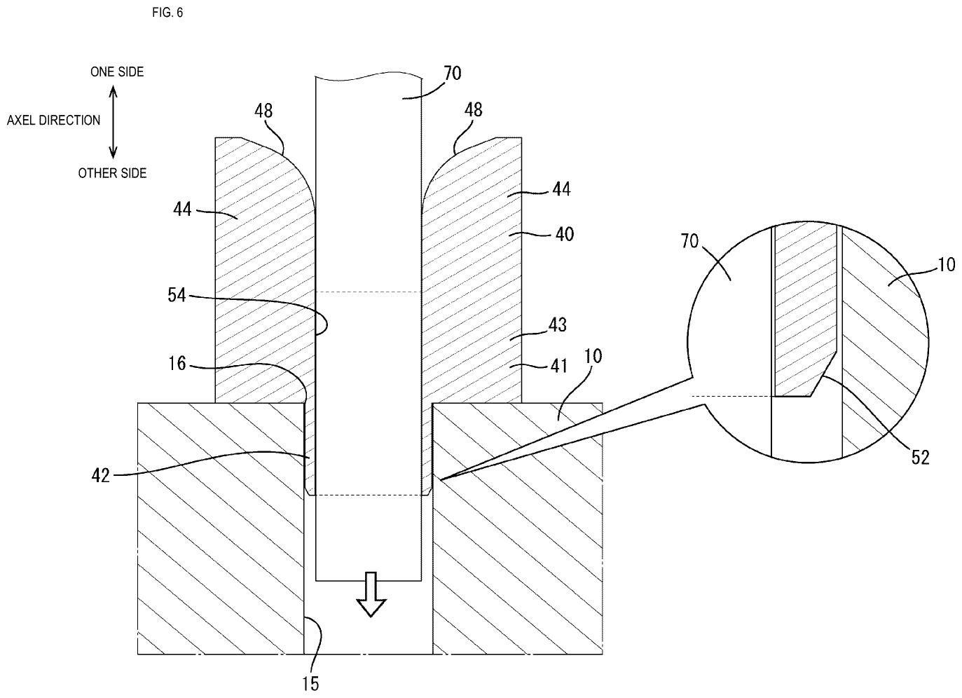

In the first placement step, the first positioning component 40 is placed so as to cover at least a portion of the opening edge on the one side in the axial direction of the slot 15 (see FIG. 6). The first positioning component 40 is inserted into the slot 15 from the protruding end side of the protrusion 42. The outer peripheral tapered surface 52 is formed on the protruding end side of the protrusion 42. Accordingly, even if the protrusion 42 deviates slightly when inserted into the slot 15, the protrusion 42 is guided into the slot 15. Accordingly, with this configuration, the protrusion 42 of the first positioning component 40 is easily inserted into the slot 15. The base portion 41 of the first positioning component 40 is placed on the one end portion in the axial direction of the stator core 10. The first positioning component 40 is placed so as to close the opening on the one side in the axial direction (the first opening 16) of the slot 15. The pair of inclined surfaces 48 of the first positioning component 40 are placed on the one side in the axial direction with respect to the protrusion 42. According to this configuration, even if the coil segment 70 deviates slightly when inserted into the protrusion 42 from the one side in the axial direction, the coil segment 70 is guided into the protrusion 42 by the inclined surfaces 48. Accordingly, with this configuration, the coil segment 70 is easily inserted into the protrusion 42 from the one side in the axial direction. Note that the coil segment 70 is a component that is included in the coil 20. The coil segment 70 has a linear shape.

In the insertion step, after the first positioning component 40 is placed, the coil segment 70 is inserted into the slot 15 from one side in the axial direction (see FIG. 6). With this configuration, the coil segment 70 is easily inserted into the slot 15 so as not to come into contact with the stator core 10. Accordingly, even if there is a burr at an opening end of the slot 15, the case where the coating portion of the insertion portion 21 is caught by the burr and peeled off is easily prevented. The coil segment 70 is passed through the tubular protrusion 42 from the one side in the axial direction to be inserted into the slot 15. The coil segment 70 is passed between the pair of inclined surfaces 48 to be inserted into the tubular base portion 41. The pair of inclined surfaces 48 are inclined so that the distance from each other increases toward the one side in the axial direction. According to this configuration, even if the coil segment 70 deviates slightly in the circumferential direction when inserted into the base portion 41, the coil segment 70 is guided into the base portion 41 by the pair of inclined surfaces 48. Accordingly, with this configuration, the coil segment 70 is easily inserted into the protrusion 42 from the one side in the axial direction.

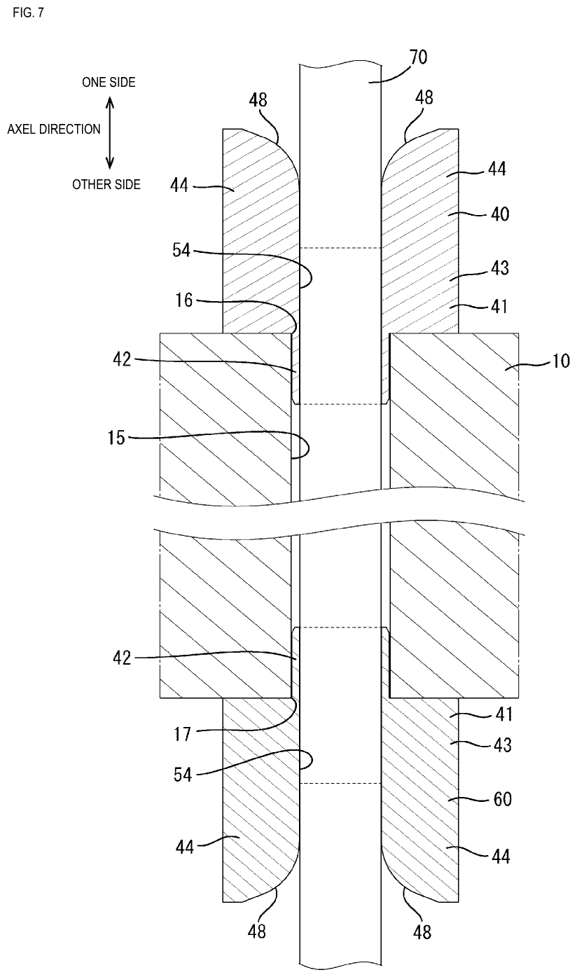

In the attachment step, the second positioning component 60 is attached to the coil segment 70, which has been inserted into the slot 15 in the insertion step, from the other side in the axial direction (see FIG. 7). That is, in the attachment step, the second positioning component 60 is attached to the coil segment 70 that extends from the opening (the second opening 17) on the other side in the axial direction of the slot 15. In the attachment step, the coil segment 70 is inserted into the tubular protrusion 42 of the second positioning component 60. The second positioning component 60 is attached to the coil segment 70 in an orientation opposite to that of the first positioning component 40.

In the second placement step, the second positioning component 60 is placed so as to cover at least a portion of an opening edge on the other side in the axial direction of the slot 15 (see FIG. 7). The second positioning component 60 is inserted into the slot 15 from the protruding end side of the protrusion 42. The outer tapered surface 52 is formed on the protruding end side of the protrusion 42. Accordingly, even if the protrusion 42 deviates slightly when inserted into the slot 15, the protrusion 42 is guided into the slot 15. Accordingly, with this configuration, the protrusion 42 of the second positioning component 60 is easily inserted into the slot 15. The base portion 41 of the second positioning component 60 is placed at the other end portion in the axial direction of the stator core 10. The second positioning component 60 is placed so as to cover the opening (the second opening 17) on the other side in the axial direction of the slot 15. The pair of inclined surfaces 48 of the second positioning component 60 are placed on the other side in the axial direction with respect to the protrusion 42.

In the filling step, a gap between the inner wall of the slot 15 and the coil segment 70 in the center portion in the axial direction of the slot 15 is continuously filled with an insulating resin 30 (see FIG. 8). Since the gap between the inner wall of the slot 15 and the coil segment 70 is continuously filled with the insulating resin 30, the heat of the coil segment 70 is easily dissipated via the insulating resin 30, and as a result, heat dissipation of the coil 20 can be improved. When filling with the insulating resin 30, the opening on the one side in the axial direction of the slot 15 (the first opening 16) is closed by the first positioning component 40. The opening on the other side in the axial direction of the slot 15 (the second opening 17) is closed by the second positioning component 60. The opening on the radially inner side of the slot 15 (the third opening 18) is closed by another member except for the resin injection portion. Then, the slot 15 is filled with the insulating resin 30 through the third opening 18. With this configuration, leakage of the insulating resin 30 from both sides in the axial direction of the slot 15 is easily prevented by the first positioning component 40 and the second positioning component 60. The filling step is performed in the state where the coil segment 70 is positioned by the first positioning component 40 and the second positioning component 60. With this configuration, when the insulating resin 30 is solidified, the coil segment 70 is easily placed at an appropriate position.

In the bending step, the one end side of the coil segment 70 is bent along the inclined surfaces 48 of the first positioning component 40 (see FIG. 8). The first extended portion 23 is thus formed. With this configuration, the inclined surfaces 48 that guide the coil segment 70 can be used to bend the coil segment 70. In the bending step, the other end side of the coil segment 70 is bent along the inclined surfaces 48 of the second positioning component 60. The second extended portion 25 is thus formed.

In the welding step, the first extended portion 23 of the coil segment 70 is welded to another coil component (e.g., a first extended portion 23 of another coil segment 70). Also, in the welding step, the second extended portion 25 of the coil segment 70 is welded to another coil component (e.g., a second extended portion 25 of another coil segment 70). The stator 1 is produced through these steps.

### Second Embodiment

In a second embodiment, a first alternative embodiment of the second positioning component will be described. In the following description, configurations that are the same as in the first embodiment are denoted by the same reference signs, and redundant description thereof is omitted.

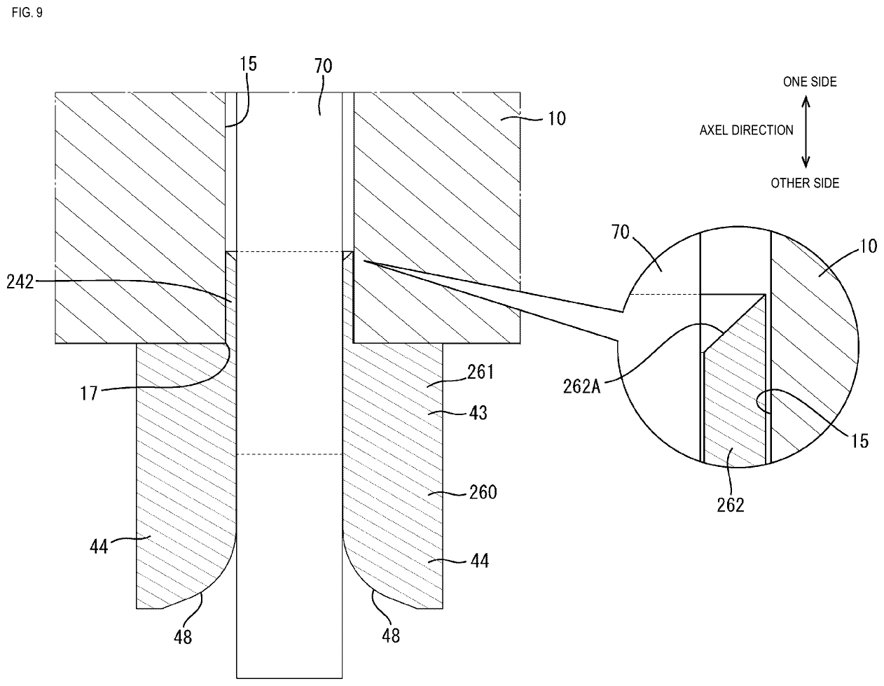

A second positioning component 260 of the second embodiment corresponds to the “second jig”. The second positioning component 260 has insulating properties and is made of resin or ceramic, for example. The second positioning component 260 has an annular shape. As shown in FIG. 9, the second positioning component 260 includes a second base portion 261 that is disposed at the other end portion of the stator core 10, and a second protrusion 262 that protrudes in a tubular shape from the second base portion 261. The second base portion 261 has the same form as the base portion 41 of the first embodiment.

The second protrusion 262 protrudes in a tubular shape from the second base portion 261 to the opposite side to the projection 44 side (the other side in the axial direction). The second protrusion 262 protrudes in a tubular shape from the inner periphery of the tubular second base portion 261. The second protrusion 262 has a quadrangular tube shape.

The inner peripheral surface of the second protrusion 262 is continuous with the inner peripheral surface of the second base portion 261 (annular base portion 43) without a stepped portion. The inner peripheral surface of the second protrusion 262 has an inner peripheral tapered surface 262A formed such that a hole in the second protrusion 262 widens toward the protruding end.

The second positioning component 260 differs from the second positioning component 60 (first positioning component 40) of the first embodiment in that the inner peripheral tapered surface 262A is provided and the outer peripheral tapered surface 52 is not provided, and is the same in other aspects.

Similarly to the method for producing the stator 1 of the first embodiment, the method for producing the stator of the second embodiment includes the first placement step, the insertion step, the attachment step, the second placement step, the filling step, the bending step and the welding step.

That is, in the attachment step, the second positioning component 260 is attached from the other side in the axial direction to the coil segment 70 that has been inserted into the slot 15 in the insertion step. In the attachment step, the second positioning component 260 is attached to the coil segment 70 by inserting the coil segment 70 into the second positioning component 260 from the protruding end side of the second protrusion 262.

According to this configuration, since the inner peripheral surface of the second protrusion 262 has the inner peripheral tapered surface 262A, even if the coil segment 70 deviates slightly when passed into the second protrusion 262, the coil segment 70 is guided into the second protrusion 262 by the inner peripheral tapered surface 262A. Accordingly, with this configuration, the second positioning component 260 is easily attached to the coil segment 70.

### Third Embodiment

In a third embodiment, a second alternative embodiment of the second positioning component will be described. The second positioning component of the third embodiment differs from the positioning component of the second embodiment in that a second outer peripheral tapered surface is provided in addition to the inner peripheral tapered surface, and is the same in other aspects. In the following description, configurations that are the same as in the first embodiment are denoted by the same reference signs, and redundant description thereof is omitted.

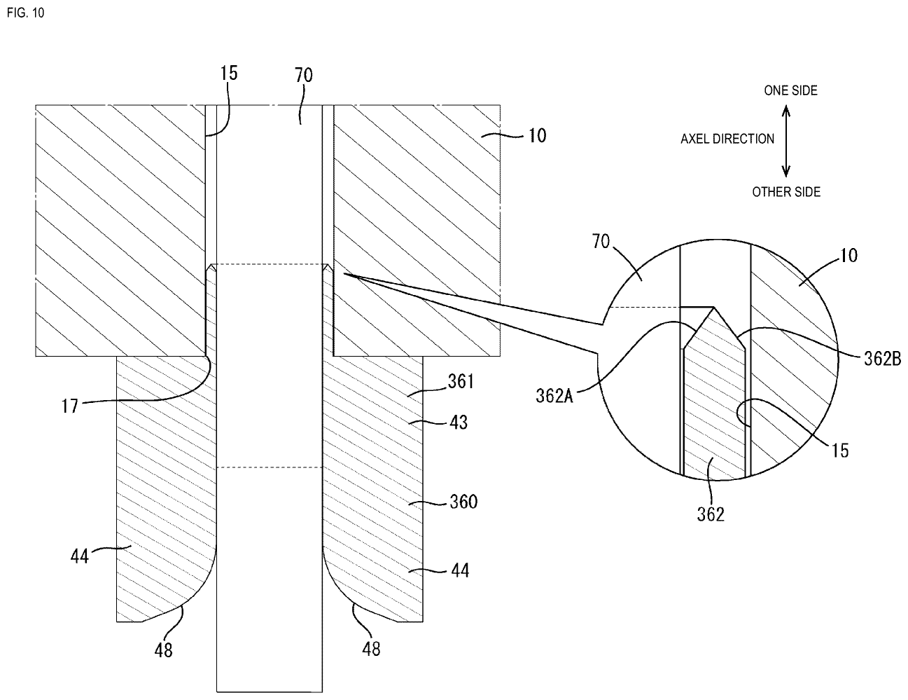

A second positioning component 360 of the third embodiment corresponds to an example of the “second jig”. The second positioning component 360 has insulating properties, and is made of resin or ceramic, for example. The second positioning component 360 has an annular shape. As shown in FIG. 10, the second positioning component 360 includes a second base portion 361 that is disposed at the other end portion of the stator core 10, and a second protrusion 362 that protrudes in a tubular shape from the second base portion 361. The second base portion 361 has the same form as the base portion 41 of the first embodiment.

The second protrusion 362 protrudes in a tubular shape from the second base portion 361 to the opposite side to the projections 44 side (the other side in the axial direction). The second protrusion 362 protrudes in a tubular shape from the inner periphery of the tubular second base portion 361. The second protrusion 362 has a quadrangular tube shape.

The inner peripheral surface of the second protrusion 362 is continuous with the inner peripheral surface of the second base portion 361 (annular base portion 43) without a stepped portion. The inner peripheral surface of the second protrusion 362 has an inner peripheral tapered surface 362A formed such that a hole in the second protrusion 362 widens toward the protruding end.

The outer peripheral surface of the second protrusion 362 includes a second outer peripheral tapered surface 362B that is tapered toward the protruding end.

The second positioning component 360 differs from the second positioning component 60 (first positioning component 40) of the first embodiment in that the inner peripheral tapered surface 362A is provided and the second outer peripheral tapered surface 362B is provided instead of the outer peripheral tapered surface 52, and is the same in other aspects.

Similarly to the method for producing the stator 1 of the first embodiment, the method for producing the stator of the third embodiment includes the first placement step, the insertion step, the attachment step, the second placement step, the filling step, the bending step, and the welding step.

Specifically, in the second placement step, by inserting the second protrusion 362 into the slot 15 from the protruding end side, the second positioning component 360 is placed at the end portion on the other side in the axial direction of the stator core 10.

According to this configuration, since the second outer peripheral tapered surface 362B is formed on the protruding end side of the second protrusion 362, even if the second protrusion 362 deviates slightly when inserted into the slot 15 from the protruding end side, the second protrusion 362 is guided into the slot 15 by the second outer peripheral tapered surface 362B. Accordingly, with this configuration, the second positioning component 360 is easily inserted into the slot 15. That is, since the inner peripheral tapered surface 362A and the second outer peripheral tapered surface 362B are formed on the protruding end side of the second protrusion 362, the second positioning component 360 is easily attached to the coil segment 70 and inserted into the slot 15.

### OTHER EMBODIMENTS

The present disclosure is not limited to the embodiments described by way of the above descriptions and figures. For example, the features of the embodiments described above and below can be combined in any way as long as no contradiction arises. Also, any feature of the above embodiments can also be omitted unless otherwise specified as essential.

In the above embodiments, the first positioning component that is one component of the stator is used as the first jig, and the second positioning component is used as the second jig. However, a jig that is not a component of the stator can be used to produce a stator.

In the second embodiment, the first positioning component may have the same form as the second positioning component.

In the third embodiment, the first positioning component may have the same form as the second positioning component.

The embodiment disclosed here is to be considered in all respects as illustrative and not limiting. The scope of the present disclosure is not intended to be limited to the embodiments disclosed herein, but rather is indicated by the scope of the claims, and is intended to include all modifications within the meaning and scope of equivalents of the scope of the claims.

1. A stator comprising:
an annular stator core;
a coil;
an insulating resin; and
a positioning component,
wherein the stator core includes a plurality of slots that are arranged in an annular shape and extend through the stator core in an axial direction,
the coil includes an insertion portion that passes through a slot of the plurality of slots,
the insulating resin includes a continuous filling portion located in a center portion in the axial direction inside the slot, and that continuously fills a space between an inner wall of the slot and the insertion portion,
the positioning component positions the insertion portion in a state where, on one side in the axial direction with respect to the continuous filling portion, at least a portion of the positioning component enters between the inner wall of the slot and the insertion portion,
the positioning component has a pair of positioning surfaces, and
the pair of positioning surface are disposed so as to be continuous inside and outside of the slot in the axial direction without a stepped portion, and position the insertion portion on both the inside and outside of the slot.

2. (canceled)

3. The stator according to claim 1, further including;
a second positioning component that positions the insertion portion in a state where, on the other side in the axial direction with respect to the continuous filling portion, at least a portion of the second positioning component enters between the inner wall of the slot and the insertion portion, and
the insertion portions are positioned by the positioning component and the second positioning component.

4. The stator according to claim 1,
wherein the coil has an extended portion that extends from one end of the insertion portion via a bent portion, and
the positioning component has an inclined surface that extends along the extended portion.

5. (canceled)

6. A method for producing a stator including an annular stator core and a coil segment, the stator core having a plurality of slots that are arranged in an annular shape and extend through the stator core in an axial direction, the method comprising:
a placement step of placing a jig so as to cover at least a portion of an opening edge on one side in the axial direction of a slot of the plurality of slots, and such that a pair of positioning surfaces included in the jig are continuous inside and outside of the slot without a stepped portion;
an insertion step of inserting the coil segment in the slot from the one side in the axial direction after placing the jig, and
a filling step of continuously filling a space between an inner wall of the slot and the coil segment in a center portion in the axial direction inside the slot, with an insulating resin.

7. The method for producing a stator according to claim 6, wherein in the filling step, the slot is filled with the insulating resin while an opening on the one side in the axial direction of the slot is closed by the jig.

8. The method for producing a stator according to claim 6,
wherein the jig includes a base portion disposed at an end portion on the one side in the axial direction of the stator core and a protrusion that protrudes in a tubular shape from the base portion and through which the coil segment is passed,
an outer peripheral surface of the protrusion includes an outer peripheral tapered surface that is tapered toward a protruding end of the protrusion, and
in the placement step, the jig is disposed by inserting the protrusion into the slot from the protruding end side.

9. A method for producing a stator including an annular stator core and a coil segment, the stator core having a plurality of slots that are arranged in an annular shape and extend through the stator core in an axial direction, the method comprising:
a placement step of placing a jig so as to cover at least a portion of an opening edge on one side in the axial direction of a slot of the plurality of slots;
an insertion step of inserting the coil segment in the slot from the one side in the axial direction after placing the jig;
an attachment step of attaching a second jig to the coil segment that has been inserted into the slot in the insertion step, from the other side in the axial direction, and
a filling step of continuously filling a space between an inner wall of the slot and the coil segment in a center portion in the axial direction inside the slot, with an insulating resin,
wherein, in the filling step, the slot is filled with the insulating resin while an opening on the one side in the axial direction of the slot is closed by the jig and an opening on the other side in the axial direction is closed by the second jig,
the second jig includes a second base portion disposed at an end portion on the other side in the axial direction of the stator core, and a second protrusion that protrudes in a tubular shape from the second base portion,
an inner peripheral surface of the second protrusion is continuous with an inner peripheral surface of the second base portion, without a stepped portion,
the inner peripheral surface of the second protrusion includes an inner peripheral tapered surface formed such that a hole in the second protrusion widens toward the protruding end, and
in the attachment step, the second jig is attached to the coil segment by inserting the coil segment into the second jig from the protruding end side of the second protrusion.

10. The method for producing a stator according to claim 9,
wherein an outer peripheral surface of the second protrusion has a second outer peripheral tapered surface that is tapered toward the protruding end,
the method further comprising
a second placement step of placing the second jig at the end portion on the other side in the axial direction of the stator core by inserting the second protrusion into the slot from the protruding end side.

11. The method for producing a stator according to claim 8,
wherein the base portion of the jig includes an inclined surface that guides the coil segment into the protrusion, and
in the placement step, the jig is placed such that the inclined surface is placed on the one side in the axial direction with respect to the protrusion.

12. The method for producing a stator according to claim 11, further including;
a bending step of bending the coil segment along the inclined surface.

13. The stator according to claim 3,
wherein the coil has an extended portion that extends from one end of the insertion portion via a bent portion, and
the positioning component has an inclined surface that extends along the extended portion.

14. The method for producing a stator according to claim 7,
wherein the jig includes a base portion disposed at an end portion on the one side in the axial direction of the stator core and a protrusion that protrudes in a tubular shape from the base portion and through which the coil segment is passed,
an outer peripheral surface of the protrusion includes an outer peripheral tapered surface that is tapered toward a protruding end of the protrusion, and
in the placement step, the jig is disposed by inserting the protrusion into the slot from the protruding end side.
